(19) United States
(12) Patent Application Publication
(10) Pub. No.: US 2013/0201855 A1
(43) Pub. Date: Aug. 8, 2013

(54) MICROWAVE ANTENNA ALIGNMENT METHOD AND APPARATUS

(71) Applicant: Huawei Technologies Co., Ltd., Shenzhen (CN)

(72) Inventors: Xin Luo, Chengdu (CN); Yi Chen, Chengdu (CN); Rui Lv, Chengdu (CN)

(73) Assignee: Huawei Technologies Co., Ltd., Shenzhen (CN)

(21) Appl. No.: 13/786,298

(22) Filed: Mar. 5, 2013

Related U.S. Application Data
(63) Continuation of application No. PCT/CN2011/083789, filed on Dec. 9, 2011.

(51) Int. Cl. H04B 17/00

(52) U.S. Cl. CPC H04B 17/0062
USPC 370/252; 455/226.1

(57) ABSTRACT

The present invention discloses a microwave antenna alignment method and apparatus, relating to the field of communications technologies, and providing a clear instruction for antenna adjustment and implementing more convenient antenna alignment. The microwave antenna alignment method includes: performing vector subtraction for in-phase signals received by two sub-antennas within a same horizontal plane to obtain an azimuth plane vector difference, where an azimuth plane angular error signal includes the azimuth plane vector difference, and the azimuth plane angular error signal is used to reflect a deviation angle and direction of a received beam from the antenna direction within the horizontal plane; and aligning the antenna within the horizontal plane according to the azimuth plane angular error signal.

### CROSS-REFERENCE TO RELATED APPLICATIONS

This application is a continuation of International Application No. PCT/CN2011/083789, filed on Dec. 9, 2011, which is hereby incorporated by reference in its entirety.

### TECHNICAL FIELD

The present invention relates to the field of communications technologies, and in particular, to a microwave antenna alignment method and apparatus.

### BACKGROUND

Beam width of a microwave antenna is small. Therefore, the antenna needs to be aligned to ensure success of communication. In the prior art, a received signal strength indicator (Received Signal Strength Indication, RSSI) interface is set on an outdoor unit (Out Door Unit, ODU). An internal detection circuit of the ODU outputs an RSSI voltage according to the strength of a received signal. A worker first roughly adjusts the antenna according to the longitude, latitude, and altitude of the location of the antenna to achieve approximate alignment of the antenna, and then finely adjusts the antenna while monitoring the RSSI voltage value until the RSSI voltage reaches a preset threshold. During the alignment process, only an indication of signal strength is presented. Therefore, the antenna needs to be adjusted toward different directions, wasting time and manpower.

### SUMMARY

Embodiments of the present invention provide a microwave antenna alignment method and apparatus, providing a clear instruction for antenna adjustment and implementing more convenient antenna alignment.

To solve the preceding technical problems, the embodiments of the present invention adopt the following technical solutions:

A microwave antenna alignment method includes:

performing vector subtraction for in-phase signals received by two sub-antennas within a same horizontal plane to obtain an azimuth plane vector difference, where an azimuth plane angular error signal includes the azimuth plane vector difference, and the azimuth plane angular error signal is used to reflect a deviation angle and direction of a received beam from the antenna direction within the horizontal plane; and

aligning the antenna within the horizontal plane according to the azimuth plane angular error signal.

A microwave antenna alignment method includes:

performing vector subtraction for in-phase signals received by two sub-antennas within a same vertical plane to obtain a pitch plane vector difference, where a pitch plane angular error signal includes the pitch plane vector difference, and the pitch plane angular error signal is used to reflect a deviation angle and direction of a received beam from the antenna direction within the vertical plane; and

aligning the antenna within the vertical plane according to the pitch plane angular error signal.

A microwave antenna alignment apparatus includes:

an error signal calculating unit, configured to perform vector subtraction for in-phase signals received by two sub-antennas within a same horizontal plane to obtain an azimuth plane, where an azimuth plane angular error signal includes the azimuth plane vector difference, and the azimuth plane angular error signal is used to reflect a deviation angle and direction of a received beam from the antenna direction within the horizontal plane; and

an aligning unit, configured to align the antenna within the horizontal plane according to the azimuth plane angular error signal.

A microwave antenna alignment apparatus includes:

an error signal calculating unit, configured to perform vector subtraction for in-phase signals received by two sub-antennas within a same vertical plane to obtain a pitch plane vector difference, where a pitch plane angular error signal includes the pitch plane vector difference, and the pitch plane angular error signal is used to reflect a deviation angle and direction of a received beam from the antenna direction within the vertical plane; and

an aligning unit, configured to align the antenna within the vertical plane according to the azimuth plane angular error signal.

A mapping relationship exists between the azimuth plane angular error signal and the deviation angle of the received beam from the antenna direction within the horizontal plane. A mapping relationship exists between the pitch plane angular error signal and the deviation angle of the received beam from the antenna direction within the vertical plane. The plus or minus of the error signal reflects the deviation direction. Within a specific range, the size of the error signal reflects the size of the deviation angle. The antenna may be adjusted according to the deviation angle and direction of the received beam from the antenna direction within the horizontal plane or vertical plane, which, compared with the prior art where the antenna needs to be adjusted toward different directions in the alignment process, provides a clear instruction for antenna adjustment and implements more convenient antenna alignment.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following descriptions merely show some embodiments of the present invention, and persons of ordinary skill in the art can derive other drawings from the accompanying drawings without creative efforts.

FIG. 1 is a flowchart of a microwave antenna alignment method according to Embodiment 1 of the present invention;

FIG. 2 is a graph of the function between a deviation angle of a received beam from the antenna direction and amplitudes of signals received by two sub-antennas within a same horizontal plane;

FIG. 3 is a schematic diagram of a mapping relationship between an azimuth plane angular error signal and a deviation angle of a received beam from the antenna direction within a horizontal plane;

FIG. 4 is a flowchart of a microwave antenna alignment method according to Embodiment 2 of the present invention;

FIG. 5 is a schematic diagram of a mapping relationship between a pitch plane angular error signal and a deviation angle of a received beam from the antenna direction within a vertical plane;

FIG. 6 is a flowchart of a microwave antenna alignment method according to Embodiment 3 of the present invention;

FIG. 7 is a flowchart of a microwave antenna alignment method according to Embodiment 4 of the present invention;

FIG. 8 is a structural block diagram of a microwave antenna alignment apparatus according to Embodiment 5 or Embodiment 7 of the present invention;

FIG. 9 is a structural block diagram of a microwave antenna alignment apparatus according to Embodiment 6 of the present invention; and

FIG. 10 is a structural block diagram of the error signal calculating unit in FIG. 8 implemented by using a vector superposing network.

### DETAILED DESCRIPTION

The following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative efforts shall fall within the protection scope of the present invention.

### Embodiment 1

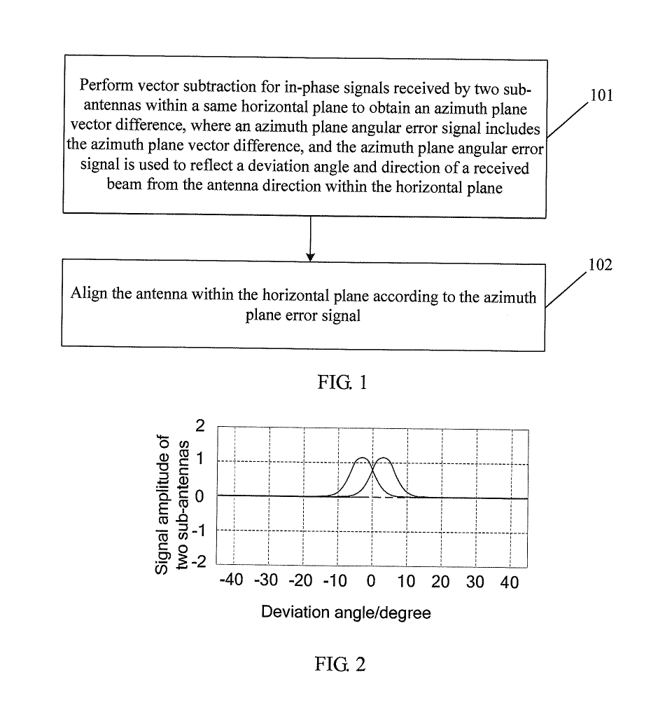

As shown in FIG. 1, an embodiment of the present invention provides a microwave antenna alignment method, including:

Step 101: Perform vector subtraction for in-phase signals received by two sub-antennas within a same horizontal plane to obtain an azimuth plane vector difference, where an azimuth plane angular error signal includes the azimuth plane vector difference, and the azimuth plane angular error signal is used to reflect a deviation angle and direction of a received beam from the antenna direction within the horizontal plane.

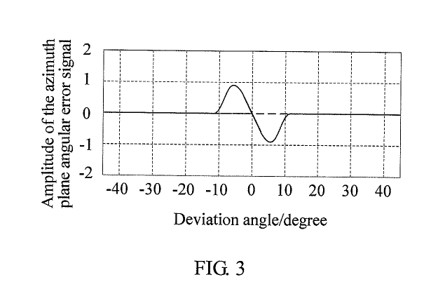

Specifically, the above two sub-antennas are installed at different positions. Therefore, when the antenna is not aligned within a specific range, the amplitudes of the signals received by the two sub-antennas are different. As shown in FIG. 2, graphs of functions between the deviation angle of the received beam from the antenna direction and the amplitudes of the signals received by the two sub-antennas are two different parabolas within a specific range. As shown in FIG. 3, the azimuth plane angular error signal is obtained by performing vector subtraction for the in-phase signals received by two sub-antennas within the same horizontal plane (that is, the azimuth plane). The azimuth plane angular error signal is used to reflect the deviation angle and direction of the received beam from the antenna direction within the horizontal plane. A mapping relationship exists between the azimuth plane angular error signal and the deviation angle of the received beam from the antenna direction within the horizontal plane. The x-coordinate indicates the deviation angle, and the y-coordinate indicates the amplitude of the azimuth plane angular error signal. The plus or minus of the error signal reflects the deviation direction. Within a specific range, the size of the error signal reflects the size of the deviation angle. When the error signal is zero, the antenna is aligned.

Step 102: Align the antenna within the horizontal plane according to the azimuth plane angular error signal.

The microwave antenna alignment method provided in this embodiment of the present invention is capable of adjusting the antenna according to the reflected deviation angle and direction of the received beam from the antenna direction within the horizontal plane, which, compared with the prior art where the antenna needs to be adjusted toward different directions in the alignment process, provides a clear instruction for antenna adjustment and implements more convenient antenna alignment.

### Embodiment 2

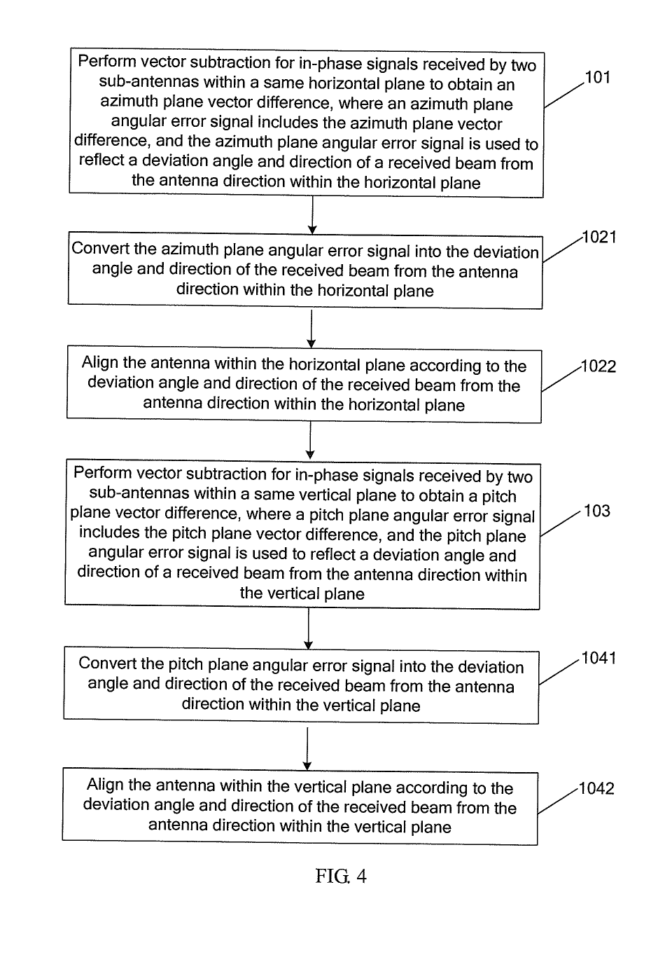

Based on Embodiment 1, as shown in FIG. 4, an embodiment of the present invention further provides a microwave antenna alignment method, where the azimuth plane angular error signal further includes: an azimuth plane vector difference obtained by performing vector subtraction for in-phase signals received by another two sub-antennas having a same symmetry axis as the two sub-antennas within the same horizontal plane; or an azimuth plane vector difference obtained by performing vector subtraction for in-phase signals received by another two sub-antennas having a same symmetry axis as the two sub-antennas within a different horizontal plane. The azimuth plane vector difference obtained by performing vector subtraction for another two sub-antennas having a same symmetry axis as the two sub-antennas within the same horizontal plane is equal to the azimuth plane vector difference obtained in Embodiment 1. Therefore, the sum of the vector differences also reflects the deviation angle and direction from the antenna direction, that is, the azimuth plane angular error signal.

The aligning the antenna within the horizontal plane according to the azimuth plane angular error signal in step 102 specifically includes:

Step 1021: Convert the azimuth plane angular error signal into the deviation angle and direction of the received beam from the antenna direction within the horizontal plane.

Specifically, the conversion is performed according to the mapping relationship between the azimuth plane angular error signal and the deviation angle of the received beam from the antenna direction within the horizontal plane.

Step 1022: Align the antenna within the horizontal plane according to the deviation angle and direction of the received beam from the antenna direction within the horizontal plane.

The microwave antenna alignment method provided in this embodiment of the present invention further includes:

Step 103: Perform vector subtraction for in-phase signals received by two sub-antennas within a same vertical plane to obtain a pitch plane vector difference, where a pitch plane angular error signal includes the pitch plane vector difference, and the pitch plane angular error signal is used to reflect a deviation angle and direction of a received beam from the antenna direction within the vertical plane.

Furthermore, the pitch plane angular error signal further includes: a pitch plane vector difference obtained by performing vector subtraction for in-phase signals received by another two sub-antennas having a same symmetry axis as the two sub-antennas within the same vertical plane; or a pitch plane vector difference obtained by performing vector subtraction for in-phase signals received by another two sub-antennas having a same symmetry axis as the two sub-antennas within a different vertical plane.

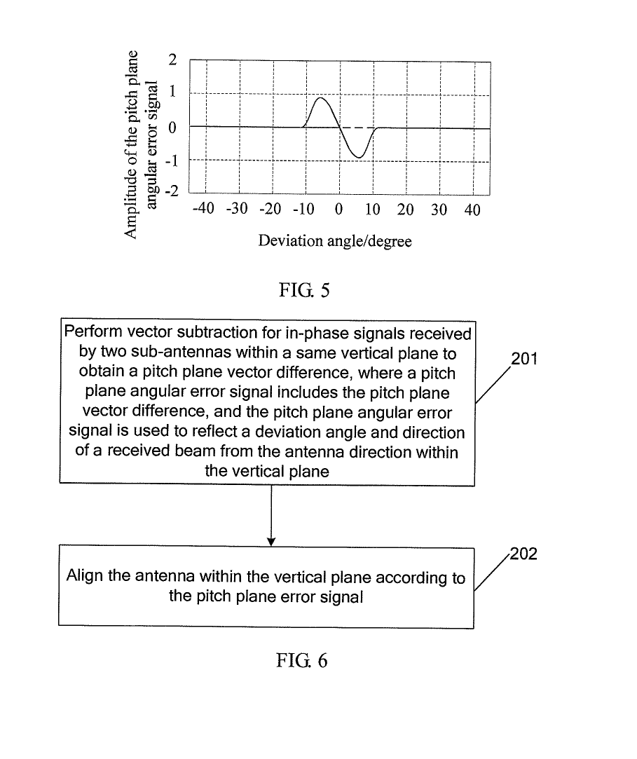

Based on the same principles of calculating the azimuth plane angular error signal, the pitch plane angular error signal is obtained by performing vector subtraction for the in-phase signals received by two sub-antennas within the same vertical plane (that is, the pitch plane) and performing vector subtraction for another two sub-antennas having a same symmetry axis as the two sub-antennas within the vertical plane. The pitch plane angular error signal is used to reflect the deviation angle and direction of the received beam from the antenna direction within the vertical plane. As shown in FIG. 5, a mapping relationship exists between the pitch plane angular error signal and the deviation angle of the received beam from the antenna direction within the vertical plane. The x-coordinate indicates the deviation angle, and the y-coordinate indicates the amplitude of the pitch plane angular error signal. The plus or minus of the error signal reflects the deviation direction. Within a specific range, the size of the error signal reflects the size of the deviation angle. When the error signal is zero, the antenna is aligned.

Step 104: Align the antenna within the vertical plane according to the pitch plane angular error signal.

Further, the aligning the antenna within the vertical plane according to the pitch plane angular error signal in step 104 specifically includes:

Step 1041: Convert the pitch plane angular error signal into the deviation angle and direction of the received beam from the antenna direction within the vertical plane.

Specifically, the conversion is performed according to the mapping relationship between the pitch plane angular error signal and the deviation angle of the received beam from the antenna direction within the vertical plane.

Step 1042: Align the antenna within the vertical plane according to the deviation angle and direction of the received beam from the antenna direction within the vertical plane.

It should be noted that step 101 and step 103 are not subject to any logic sequence.

The microwave antenna alignment method provided in this embodiment of the present invention is capable of adjusting the antenna according to the deviation angle and direction of the received beam from the antenna direction within the horizontal plane and vertical plane, which, compared with the prior art where the antenna needs to be adjusted toward different directions in the alignment process, provides a clear instruction for antenna adjustment and implements more convenient antenna alignment. In addition, as shown in FIGS. 3 and 5, the curve close to the zero point is very steep, and therefore the azimuth plane angular error signal and the pitch plane angular error signal are easy to capture when they are zero, which, compared with the case where the RSSI voltage change is small after antenna alignment in the prior art, facilitates precise antenna alignment.

### Embodiment 3

As shown in FIG. 6, an embodiment of the present invention further provides a microwave antenna alignment method, including:

Step 201: Perform vector subtraction for in-phase signals received by two sub-antennas within a same vertical plane to obtain a pitch plane vector difference, where a pitch plane angular error signal includes the pitch plane vector difference, and the pitch plane angular error signal is used to reflect a deviation angle and direction of a received beam from the antenna direction within the vertical plane.

The specific principles are the same as the principles in the above embodiment and are not detailed herein.

Step 202: Align the antenna within the vertical plane according to the pitch plane angular error signal.

The microwave antenna alignment method provided in this embodiment of the present invention is capable of adjusting the antenna according to the deviation angle and direction of the received beam from the antenna direction within the vertical plane, which, compared with the prior art where the antenna needs to be adjusted toward different directions in the alignment process, provides a clear instruction for antenna adjustment and implements more convenient antenna alignment.

### Embodiment 4

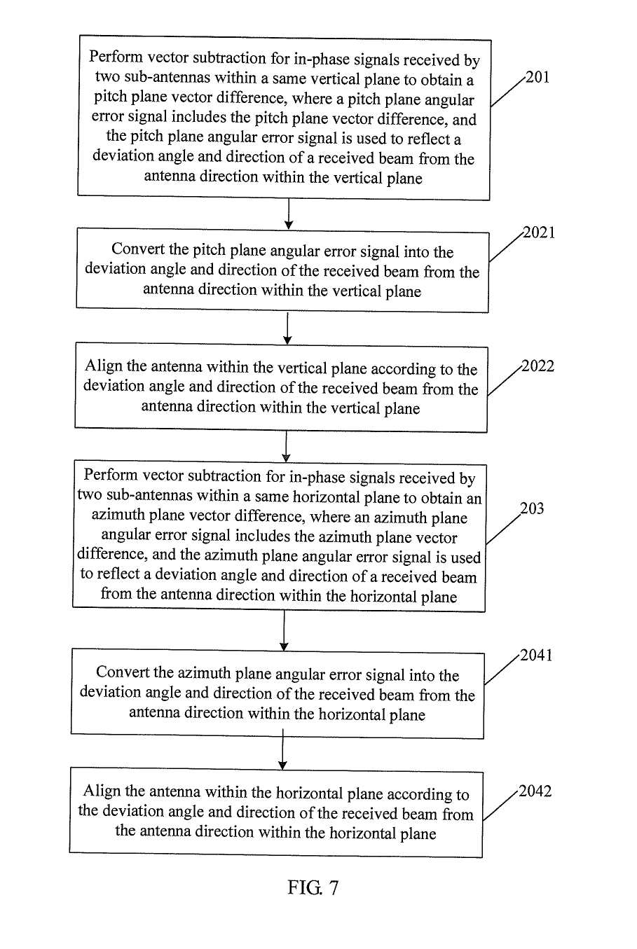

Based on Embodiment 3, as shown in FIG. 7, an embodiment of the present invention further provides a microwave antenna alignment method, where the pitch plane angular error signal further includes: a pitch plane vector difference obtained by performing vector subtraction for in-phase signals received by another two sub-antennas having a same symmetry axis as the two sub-antennas within the same vertical plane; or a pitch plane vector difference obtained by performing vector subtraction for in-phase signals received by another two sub-antennas having a same symmetry axis as the two sub-antennas within a different vertical plane.

The aligning the antenna within the vertical plane according to the pitch plane angular error signal in step 202 specifically includes:

Step 2021: Convert the pitch plane angular error signal into the deviation angle and direction of the received beam from the antenna direction within the vertical plane.

Step 2022: Align the antenna within the vertical plane according to the deviation angle and direction of the received beam from the antenna direction within the vertical plane.

The microwave antenna alignment method provided in this embodiment of the present invention further includes:

Step 203: Perform vector subtraction for in-phase signals received by two sub-antennas within a same horizontal plane to obtain an azimuth plane vector difference, where an azimuth plane angular error signal includes the azimuth plane vector difference, and the azimuth plane angular error signal is used to reflect a deviation angle and direction of a received beam from the antenna direction within the horizontal plane.

Furthermore, the azimuth plane angular error signal further includes: an azimuth plane vector difference obtained by performing vector subtraction for in-phase signals received by another two sub-antennas having a same symmetry axis as the two sub-antennas within the same horizontal plane; or an azimuth plane vector difference obtained by performing vector subtraction for in-phase signals received by another two sub-antennas having a same symmetry axis as the two sub-antennas within a different horizontal plane.

Step 204: Align the antenna within the horizontal plane according to the azimuth plane angular error signal.

The aligning the antenna within the horizontal plane according to the azimuth plane angular error signal in step 204 specifically includes:

Step 2041: Convert the azimuth plane angular error signal into the deviation angle and direction of the received beam from the antenna direction within the horizontal plane.

Step 2042: Align the antenna within the horizontal plane according to the deviation angle and direction of the received beam from the antenna direction within the horizontal plane.

It should be noted that step 201 and step 203 are not subject to any logic sequence. The specific principles are the same as the principles in the above embodiment and are not detailed herein.

The microwave antenna alignment method provided in this embodiment of the present invention is capable of adjusting the antenna according to the deviation angle and direction of the received beam from the antenna direction within the horizontal plane and vertical plane, which, compared with the prior art where the antenna needs to be adjusted toward different directions in the alignment process, provides a clear instruction for antenna adjustment and implements more convenient antenna alignment. In addition, as shown in FIGS. 3 and 5, the curve close to the zero point is very steep, and therefore the azimuth plane angular error signal and the pitch plane angular error signal are easy to capture when they are zero, which, compared with the case where the RSSI voltage change is small after antenna alignment in the prior art, facilitates precise antenna alignment.

### Embodiment 5

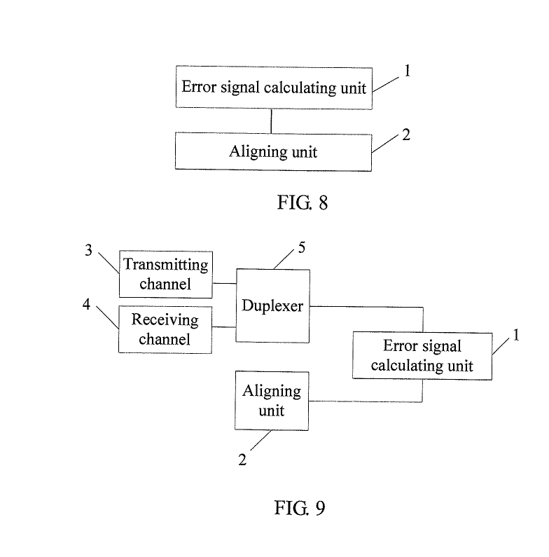

As shown in FIG. 8, an embodiment of the present invention provides a microwave antenna alignment apparatus, including:

an error signal calculating unit 1, configured to perform vector subtraction for in-phase signals received by two sub-antennas within a same horizontal plane to obtain an azimuth plane vector difference, where an azimuth plane angular error signal includes the azimuth plane vector difference, and the azimuth plane angular error signal is used to reflect a deviation angle and direction of a received beam from the antenna direction within the horizontal plane; and an aligning unit 2, configured to align the antenna within the horizontal plane according to the azimuth plane angular error signal.

The specific principles are the same as the principles in the above embodiment and are not detailed herein.

The microwave antenna alignment apparatus provided in this embodiment of the present invention is capable of adjusting the antenna according to the deviation angle and direction of the received beam from the antenna direction within the horizontal plane, which, compared with the prior art where the antenna needs to be adjusted toward different directions in the alignment process, provides a clear instruction for antenna adjustment and implements more convenient antenna alignment.

### Embodiment 6

Based on Embodiment 5, as shown in FIG. 9, an embodiment of the present invention provides a microwave antenna alignment apparatus.

The azimuth plane angular error signal further includes: an azimuth plane vector difference obtained by performing vector subtraction for in-phase signals received by another two sub-antennas having a same symmetry axis as the two sub-antennas within the same horizontal plane; or an azimuth plane vector difference obtained by performing vector subtraction for in-phase signals received by another two sub-antennas having a same symmetry axis as the two sub-antennas within a different horizontal plane.

Furthermore, the aligning unit 2 is specifically configured to convert the azimuth plane angular error signal into the deviation angle and direction of the received beam from the antenna direction within the horizontal plane; and align the antenna within the horizontal plane according to the deviation angle and direction of the received beam from the antenna direction within the horizontal plane.

Furthermore, the error signal calculating unit 1 is further configured to perform vector subtraction for in-phase signals received by two sub-antennas within a same vertical plane to obtain a pitch plane vector difference, where a pitch plane angular error signal includes the pitch plane vector difference, and the pitch plane angular error signal is used to reflect a deviation angle and direction of a received beam from the antenna direction within the vertical plane.

Furthermore, the pitch plane angular error signal further includes: a pitch plane vector difference obtained by performing vector subtraction for in-phase signals received by another two sub-antennas having a same symmetry axis as the two sub-antennas within the same vertical plane; or a pitch plane vector difference obtained by performing vector subtraction for in-phase signals received by another two sub-antennas having a same symmetry axis as the two sub-antennas within a different vertical plane.

Furthermore, the aligning unit 2 is further configured to align the antenna within the vertical plane according to the pitch plane angular error signal.

Furthermore, the aligning unit 2 is specifically configured to convert the pitch plane angular error signal into the deviation angle and direction of the received beam from the antenna direction within the vertical plane; and align the antenna within the vertical plane according to the deviation angle and direction of the received beam from the antenna direction within the vertical plane.

Furthermore, the error signal calculating unit 1 is further configured to perform vector addition for in-phase signals received by the plurality of antennas within the same horizontal plane and vertical plane to obtain receive signals; and averagely divide transmit signals to multiple paths of transmit signals having the same amplitude and phase corresponding to the plurality of antennas.

Furthermore, the apparatus further includes:

a transmitting channel 3, configured to input the transmit signals to the error signal calculating unit; a receiving channel 4, configured to receive the receive signals; and a duplexer 5, configured to isolate the transmit signals from the receive signals.

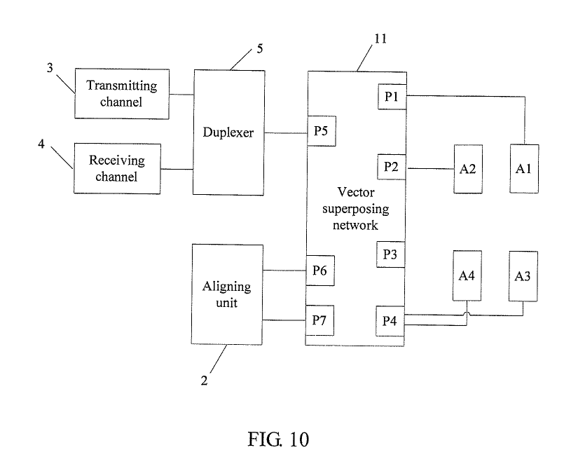

The specific principles are the same as the principles in the above embodiment and are not detailed herein. As shown in FIG. 10, the following further describe this embodiment of the present invention through an example where a vector superposing network 11 is used as the error signal calculating unit 1. A first port P1, a second port P2, a third port P3, and a fourth port P4 of the vector superposing network 11 are respectively connected to a first sub-antenna A1, a second sub-antenna A2, a third sub-antenna A3 and a fourth sub-antenna A4. The first sub-antenna A1 and the second sub-antenna A2 are in the same horizontal plane. The third sub-antenna A3 and the fourth sub-antenna A4 are in the same horizontal plane. The first sub-antenna A1 and the third sub-antenna A3 are in the same vertical plane. The second sub-antenna A2 and the fourth sub-antenna A4 are in the same vertical plane. A fifth port P5 of the vector superposing network 11 is connected to the duplexer 5. A sixth port P6 and a seventh port P7 of the vector superposing network 11 are connected to the aligning unit 2.

During the transmission process, the transmit signals are input to the vector superposing network 11 from the fifth port P5 through the transmitting channel 3 and the duplexer 5. The vector superposing network 11 averagely divides the transmit signals into four paths of transmit signals having the same amplitude and phase. The four paths of transmit signals are respectively output through the first port P1, the second port P2, the third port P3, and the fourth port P4, to the four sub-antennas for transmission.

During the reception process, the first sub-antenna A1, the second sub-antenna A2, the third sub-antenna A3 and the fourth sub-antenna A4 receive a first signal E1, a second signal E2, a third signal E3 and a fourth signal E4 having different amplitudes but the same phase. The signals are respectively input to the vector superposing network 11 through the first port P1, the second port P2, the third port P3, and the fourth port P4. The vector superposing network 11 performs vector addition and subtraction for the four paths of signals and outputs the signals. Signals E1+E2+E3+E4 are output to the duplexer 5 and the receiving channel 4 through the fifth port P5, that is, the receive signals. The azimuth plane angular error signal E1−E2+E3−E4 and the pitch plane angular error signal E1−E3+E2−E4 are respectively output to the aligning unit 2 through the sixth port P6 and the seventh port P7. According to the same principles as in the above embodiment, the aligning unit 2 converts the azimuth plane angular error signal into the deviation angle and direction of the received beam from the antenna direction within the horizontal plane, and converts the pitch plane angular error signal into the deviation angle and direction of the received beam from the antenna direction within the vertical plane. The aligning unit 2 may automatically align the antenna or indicate the deviation angle and direction of the received beam from the antenna direction for a worker to adjust.

The microwave antenna alignment apparatus provided in this embodiment of the present invention is capable of adjusting the antenna according to the deviation angle and direction of the received beam from the antenna direction within the horizontal plane and vertical plane while generating the azimuth plane angular error signal and pitch plane angular error signal without affecting transmission of wanted signals, which, compared with the prior art where the antenna needs to be adjusted toward different directions in the alignment process, provides a clear instruction for antenna adjustment and implements more convenient antenna alignment. In addition, as shown in FIGS. 3 and 5, the curve close to the zero point is very steep, and therefore the azimuth plane angular error signal and the pitch plane angular error signal are easy to capture when they are zero, which, compared with the case where the RSSI voltage change is small after antenna alignment in the prior art, facilitates precise antenna alignment.

### Embodiment 7

As shown in FIG. 8, an embodiment of the present invention provides a microwave antenna alignment apparatus, including:

an error signal calculating unit 1, configured to perform vector subtraction for in-phase signals received by two sub-antennas within a same vertical plane to obtain an azimuth plane vector difference, where a pitch plane angular error signal includes the azimuth plane vector difference, and the pitch plane angular error signal is used to reflect a deviation angle and direction of a received beam from the antenna direction within the vertical plane; and an aligning unit 2, configured to align the antenna within the vertical plane according to the azimuth plane angular error signal.

The specific principles are the same as the principles in the above embodiment and are not detailed herein.

The microwave antenna alignment apparatus provided in this embodiment of the present invention is capable of adjusting the antenna according to the deviation angle and direction of the received beam from the antenna direction within the vertical plane, which, compared with the prior art where the antenna needs to be adjusted toward different directions in the alignment process, provides a clear instruction for antenna adjustment and implements more convenient antenna alignment.

The foregoing descriptions are merely exemplary embodiments of the present invention, but not intended to limit the protection scope of the present invention. Any variation or replacement that can be easily made by persons skilled in the art without departing from the technical scope disclosed by the present invention shall fall within the protection scope of the present invention. Therefore, the protection scope of the present invention shall be subject to the protection scope of the claims.

What is claimed is:

1. A microwave antenna alignment method, comprising:
performing vector subtraction for in-phase signals received by two sub-antennas within a same horizontal plane to obtain an azimuth plane vector difference, wherein an azimuth plane angular error signal comprises the azimuth plane vector difference, and the azimuth plane angular error signal is used to reflect a deviation angle and direction of a received beam from an antenna direction within the horizontal plane; and
aligning a microwave antenna within the horizontal plane according to the azimuth plane angular error signal.

2. The microwave antenna alignment method according to claim 1, wherein
the azimuth plane angular error signal further comprises:
an azimuth plane vector difference obtained by performing vector subtraction for in-phase signals received by another two sub-antennas having a same symmetry axis as the two sub-antennas within the same horizontal plane;
or
an azimuth plane vector difference obtained by performing vector subtraction for in-phase signals received by another two sub-antennas having a same symmetry axis as the two sub-antennas within a different horizontal plane.

3. The microwave antenna alignment method according to claim 1, wherein
aligning the microwave antenna within the horizontal plane according to the azimuth plane angular error signal comprises:
converting the azimuth plane angular error signal into the deviation angle and direction of the received beam from the antenna direction within the horizontal plane; and
aligning the microwave antenna within the horizontal plane according to the deviation angle and direction of the received beam from the antenna direction within the horizontal plane.

4. The microwave antenna alignment method according to claim 3, further comprising:
performing vector subtraction for in-phase signals received by two sub-antennas within a same vertical plane to obtain a pitch plane vector difference, wherein a pitch plane angular error signal comprises the pitch plane vector difference, and the pitch plane angular error signal is used to reflect a deviation angle and direction of a received beam from the antenna direction within the vertical plane; and
aligning the microwave antenna within the vertical plane according to the pitch plane angular error signal.

5. The microwave antenna alignment method according to claim 4, wherein
the pitch plane angular error signal further comprises:
a pitch plane vector difference obtained by performing vector subtraction for in-phase signals received by another two sub-antennas having a same symmetry axis as the two sub-antennas within the same vertical plane;
or
a pitch plane vector difference obtained by performing vector subtraction for in-phase signals received by another two sub-antennas having a same symmetry axis as the two sub-antennas within a different vertical plane.

6. The microwave antenna alignment method according to claim 4, wherein
aligning the microwave antenna within the vertical plane according to the pitch plane angular error signal comprises:
converting the pitch plane angular error signal into the deviation angle and direction of the received beam from the antenna direction within the vertical plane; and
aligning the microwave antenna within the vertical plane according to the deviation angle and direction of the received beam from the antenna direction within the vertical plane.

7. A microwave antenna alignment method, comprising:
performing vector subtraction for in-phase signals received by two sub-antennas within a same vertical plane to obtain a pitch plane vector difference, wherein a pitch plane angular error signal comprises the pitch plane vector difference, and the pitch plane angular error signal is used to reflect a deviation angle and direction of a received beam from an antenna direction within the vertical plane; and
aligning a microwave antenna within the vertical plane according to the pitch plane angular error signal.

8. The microwave antenna alignment method according to claim 7, wherein
the pitch plane angular error signal further comprises:
a pitch plane vector difference obtained by performing vector subtraction for in-phase signals received by another two sub-antennas having a same symmetry axis as the two sub-antennas within the same vertical plane;
or
a pitch plane vector difference obtained by performing vector subtraction for in-phase signals received by another two sub-antennas having a same symmetry axis as the two sub-antennas within a different vertical plane.

9. The microwave antenna alignment method according to claim 7, wherein
aligning the microwave antenna within the vertical plane according to the pitch plane angular error signal comprises:
converting the pitch plane angular error signal into the deviation angle and direction of the received beam from the antenna direction within the vertical plane; and
aligning the microwave antenna within the vertical plane according to the deviation angle and direction of the received beam from the antenna direction within the vertical plane.

10. The microwave antenna alignment method according to claim 9, further comprising:
performing vector subtraction for in-phase signals received by two sub-antennas within a same horizontal plane to obtain an azimuth plane vector difference, wherein an azimuth plane angular error signal comprises the azimuth plane vector difference, and the azimuth plane angular error signal is used to reflect a deviation angle and direction of a received beam from the antenna direction within the horizontal plane; and
aligning the microwave antenna within the horizontal plane according to the azimuth plane angular error signal.

11. The microwave antenna alignment method according to claim 10, wherein
the azimuth plane angular error signal further comprises:
an azimuth plane vector difference obtained by performing vector subtraction for in-phase signals received by another two sub-antennas having a same symmetry axis as the two sub-antennas within the same horizontal plane;
or
an azimuth plane vector difference obtained by performing vector subtraction for in-phase signals received by another two sub-antennas having a same symmetry axis as the two sub-antennas within a different horizontal plane.

12. The microwave antenna alignment method according to claim 10, wherein
aligning the microwave antenna within the horizontal plane according to the azimuth plane angular error signal comprises:
converting the azimuth plane angular error signal into the deviation angle and direction of the received beam from the antenna direction within the horizontal plane; and
aligning the microwave antenna within the horizontal plane according to the deviation angle and direction of the received beam from the antenna direction within the horizontal plane.

13. A microwave antenna alignment apparatus, comprising:
an error signal calculating unit, configured to perform vector subtraction for in-phase signals received by two sub-antennas within a same horizontal plane to obtain an azimuth plane vector difference, wherein an azimuth plane angular error signal comprises the azimuth plane vector difference, and the azimuth plane angular error signal is used to reflect a deviation angle and direction of a received beam from an antenna direction within the horizontal plane; and
an aligning unit, configured to align a microwave antenna within the horizontal plane according to the azimuth plane angular error signal.

14. The microwave antenna alignment apparatus according to claim 13, wherein
the azimuth plane angular error signal further comprises:
an azimuth plane vector difference obtained by performing vector subtraction for in-phase signals received by another two sub-antennas having a same symmetry axis as the two sub-antennas within the same horizontal plane;
or
an azimuth plane vector difference obtained by performing vector subtraction for in-phase signals received by another two sub-antennas having a same symmetry axis as the two sub-antennas within a different horizontal plane.

15. The microwave antenna alignment apparatus according to claim 13, wherein
the aligning unit is configured to:
convert the azimuth plane angular error signal into the deviation angle and direction of the received beam from the antenna direction within the horizontal plane; and
align the microwave antenna within the horizontal plane according to the deviation angle and direction of the received beam from the antenna direction within the horizontal plane.

16. The microwave antenna alignment apparatus according to claim 15, wherein
the error signal calculating unit is further configured to perform vector subtraction for in-phase signals received by two sub-antennas within a same vertical plane to obtain a pitch plane vector difference, wherein a pitch plane angular error signal comprises the pitch plane vector difference, and the pitch plane angular error signal is used to reflect a deviation angle and direction of a received beam from the antenna direction within the vertical plane; and
the aligning unit is further configured to align the microwave antenna within the vertical plane according to the pitch plane angular error signal.

17. The microwave antenna alignment apparatus according to claim 16, wherein
the pitch plane angular error signal further comprises:
a pitch plane vector difference obtained by performing vector subtraction for in-phase signals received by another two sub-antennas having a same symmetry axis as the two sub-antennas within the same vertical plane;
or
a pitch plane vector difference obtained by performing vector subtraction for in-phase signals received by another two sub-antennas having a same symmetry axis as the two sub-antennas within a different vertical plane.

18. The microwave antenna alignment apparatus according to claim 16, wherein
the aligning unit is further configured to:
convert the pitch plane angular error signal into the deviation angle and direction of the received beam from the antenna direction within the vertical plane; and
align the antenna within the vertical plane according to the deviation angle and direction of the received beam from the antenna direction within the vertical plane.

19. The microwave antenna alignment apparatus according to claim 18, wherein
the error signal calculating unit is further configured to:
perform vector addition for in-phase signals received by the plurality of antennas within the same horizontal plane and vertical plane to obtain receive signals; and
averagely divide transmit signals to multiple paths of transmit signals having a same amplitude and phase corresponding to the plurality of antennas; and
the apparatus further comprises:
a transmitting channel, configured to input the transmit signals to the error signal calculating unit;
a receiving channel, configured to receive the receive signals; and
a duplexer, configured to isolate the transmit signals from the receive signals.

20. A microwave antenna alignment apparatus, comprising:
an error signal calculating unit, configured to perform vector subtraction for in-phase signals received by two sub-antennas within a same vertical plane to obtain a pitch plane vector difference, wherein a pitch plane angular error signal comprises the pitch plane vector difference, and the pitch plane angular error signal is used to reflect a deviation angle and direction of a received beam from an antenna direction within the vertical plane; and
an aligning unit, configured to align a microwave antenna within the vertical plane according to the azimuth plane angular error signal.

21. The microwave antenna alignment apparatus according to claim 20, wherein
the pitch plane angular error signal further comprises:
a pitch plane vector difference obtained by performing vector subtraction for in-phase signals received by another two sub-antennas having a same symmetry axis as the two sub-antennas within the same vertical plane;
or
a pitch plane vector difference obtained by performing vector subtraction for in-phase signals received by another two sub-antennas having a same symmetry axis as the two sub-antennas within a different vertical plane.

22. The microwave antenna alignment apparatus according to claim 20, wherein
the aligning unit is configured to convert the pitch plane angular error signal into the deviation angle and direction of the received beam from the antenna direction within the vertical plane; and
align the microwave antenna within the vertical plane according to the deviation angle and direction of the received beam from the antenna direction within the vertical plane.

23. The microwave antenna alignment apparatus according to claim 22, wherein
the error signal calculating unit is further configured to perform vector subtraction for in-phase signals received by two sub-antennas within a same horizontal plane to obtain an azimuth plane vector difference, wherein an azimuth plane angular error signal comprises the azimuth plane vector difference, and the azimuth plane angular error signal is used to reflect a deviation angle and direction of a received beam from the antenna direction within the horizontal plane; and
the aligning unit is further configured to align the microwave antenna within the horizontal plane according to the azimuth plane angular error signal.

24. The microwave antenna alignment apparatus according to claim 23, wherein
the azimuth plane angular error signal further comprises:
an azimuth plane vector difference obtained by performing vector subtraction for in-phase signals received by another two sub-antennas having a same symmetry axis as the two sub-antennas within the same horizontal plane;
or
an azimuth plane vector difference obtained by performing vector subtraction for in-phase signals received by another two sub-antennas having a same symmetry axis as the two sub-antennas within a different horizontal plane.

25. The microwave antenna alignment method according to claim 23, wherein
the aligning unit is further configured to:
convert the azimuth plane angular error signal into the deviation angle and direction of the received beam from the antenna direction within the horizontal plane; and
align the microwave antenna within the horizontal plane according to the deviation angle and direction of the received beam from the antenna direction within the horizontal plane.

26. The microwave antenna alignment apparatus according to claim 25, wherein
the error signal calculating unit is further configured to:
perform vector addition for in-phase signals received by the plurality of antennas within the same horizontal plane and vertical plane to obtain receive signals; and
averagely divide transmit signals to multiple paths of transmit signals having a same amplitude and phase corresponding to the plurality of antennas; and
the apparatus further comprises:
a transmitting channel, configured to input the transmit signals to the error signal calculating unit;
a receiving channel, configured to receive the receive signals; and
a duplexer, configured to isolate the transmit signals from the receive signals.
